(19) United States
(12) Patent Application Publication
(10) Pub. No.: US 2025/0214896 A1
(43) Pub. Date: Jul. 3, 2025

(54) THIOL / SULFIDE CONTAINING CONCRETE COMPOSITION

(71) Applicant: Yarmouk University, Irbid (JO)

(72) Inventors: Faris Abed Alkareem Salem MATALKAH, Irbid (JO); Yazan Hussein Ahmad Akkam, Irbid (JO); Mohammed Ahmed Mohammed Zaitoun, Irbid (JO)

(73) Assignee: Yarmouk University, Irbid (JO)

(21) Appl. No.: 18/401,839

(22) Filed: Jan. 2, 2024

(51) Int. Cl. C04B 24/16; C04B 28/04; C04B 103/00; C04B 103/14; C04B 103/30

(52) U.S. Cl. CPC C04B 24/16; C04B 28/04; C04B 2103/0046; C04B 2103/14; C04B 2103/302; C04B 2201/52

(57) ABSTRACT

A concrete composition may include Portland cement, aggregates, and mercapto-alcohol and/or cysteine-based monomer derivatives. Such a composition may have improved mechanical properties and durability characteristics compared to conventional concrete compositions. The mercapto-alcohol and/or cysteine-based monomer derivative may be in a range of from 0.1 to 5.0 wt. %, based on total dry concrete composition weight

### TECHNICAL FIELD

The present disclosure relates to concrete compositions, and more particularly to a concrete composition containing mercapto-alcohol and/or cysteine-based monomer derivatives to improve the mechanical properties and durability characteristics of concrete.

### BACKGROUND

Thiol compounds, which contain mercapto groups (also known as thiol groups or SH groups), possess unique reactivity and are highly valuable functional groups in organic synthesis. As a result, there is a tendency to introduce thiolate groups to monomers and polymers to enhance their utility beyond conventional applications, and to broaden their application possibilities, thus enabling them to meet the evolving needs of various industries.

The Japanese patent publication number JP202007068687 discloses a method for producing a thiol-modified monomer designed to enhance the dispersion performance of cement. A polyalkylene glycol chain-containing thiol polymer obtained using the monomer, a dispersant and cement admixture.

The Japanese patent publication number JP2010065146 discloses a polyalkylene glycol chain-containing thiol compound specifically designed for use in cement admixtures. Such publication addresses the need for a polyalkylene glycol chain-containing thiol compound that can be efficiently and cost-effectively produced for various applications, particularly in cement admixtures.

The Japanese patent publication number JP2008266620 discloses monomer mixture and its use as an admixture for cement. Additionally, such prior art document describes the production of a polyalkylene glycol chain-containing thiol polymer using the monomer mixture, as well as the inclusion of the polymer in a dispersant and admixture for cement.

The Japanese patent publication number JP1994183805 discloses a cement modifier that utilizes an aqueous emulsion. The modifier consists of a homopolymer or copolymer composed of acrylic ester units or styrene-based monomer units as the dispersed phase, and a dispersant including a mercapto group-terminated polyvinyl alcohol-based polymer.

The Chinese patent publication CN103396031, describes a polycarboxylate water reducing agent. This agent contains carboxy, sulfo, and polyoxyethylene side chains and is prepared through the polymerization reaction of monomers such as allyl polyether, acrylic acid and/or its derivatives, sodium methallyl sulfonate, and aliphatic mercapto acid. The reaction takes place under an H₂O₂-Vc oxidation-reduction initiating system.

None of the prior art documents discloses a concrete comprising mercapto-alcohol and/or cysteine-based monomer derivatives, which its incorporation in concrete composition can significantly enhance both mechanical properties and durability characteristics of the resulting concrete.

### SUMMARY

Therefore, it is an object of the present disclosure to provide a modified concrete composition, containing mercapto-alcohol and/or cysteine-based monomer derivatives to improve the mechanical properties and durability characteristics of concrete.

In aspects of the present disclosure, there is provided a concrete composition that may include Portland cement; aggregates; mercapto-alcohol and/or cysteine-based monomer.

The composition may include about 0.1% to about 5.0% by weight mercapto-alcohol and/or cysteine-based monomer derivatives.

The cysteine-based derivative(s) may have a general formula (I):

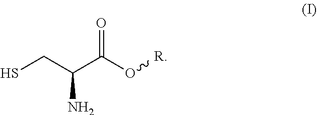

In formula (I), R may be H, a straight chain hydrocarbon, branched hydrocarbon, cyclic hydrocarbon, or aromatic hydrocarbons, which hydrocarbon may be substituted one or more alcohols, amines, amides, thiols, or carbonyl derivatives.

The mercapto-alcohol monomer derivatives may have a general formula (II):

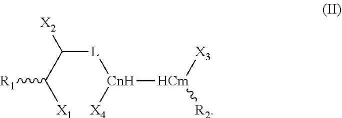

In formula (II), R₁ and R₂ may be independently H, a straight chain hydrocarbon, branched hydrocarbon, cyclic hydrocarbon, or aromatic hydrocarbons, which hydrocarbon may be substituted one or more alcohols, amines, amides, thiols, or carbonyl derivatives.

In formula (II), X₁, X₂, X₃, and X₄ may be independently OH or SH, but at least one of X₁, X₂, X₃, and X₄ should be SH.

In formula (II), n and m may be independently 0 or 1.

L may be independently H, a straight chain hydrocarbon, branched hydrocarbon, cyclic hydrocarbon, or aromatic hydrocarbons, which hydrocarbon may be substituted one or more alcohols, amines, amides, thiols, or carbonyl derivatives.

### BRIEF DESCRIPTION OF THE DRAWINGS

The disclosure will now be described with reference to the accompanying drawings, without however limiting the scope of the disclosure thereof, and in which:

FIG. 1 illustrates the high-performance liquid chromatography (HPLC) analysis showing the conversion of cysteine monomers into cystine dimers via disulfide bond formation under oxidizing conditions.

FIG. 2 illustrates the high-performance liquid chromatography (HPLC) analysis of cysteine methyl ester, revealing its monomeric state and absence of dimerization under both normal and oxidized conditions.

### DETAILED DESCRIPTION

Concrete compositions as described herein may include Portland cement, aggregates, mercapto-alcohol(s) and/or cysteine-based monomer(s). The Portland cement may be a hydraulic material comprising at least two-thirds by mass of calcium silicates, e.g., 3 CaO·SiO₂ and/or 2 CaO·SiO₂, the remainder consisting of aluminum-containing clinker, iron-containing clinker phases, and other compounds, e.g., alite, belite, tricalcium aluminate, tetracalcium alumino ferrite, etc. The mass of calcium silicates may be, e.g., at least 66.7, 70, 72.5, 75, 77.5, 80, 82.5, 85, 87.5, or 90 wt % of the Portland cement The CaO and SiO₂ may be in a CaO:SiO₂ mass ratio of at least 2.0, 2.1, 2.25, 2.5, 2.75, 3, 3.5, 4, 5, 7.5, 10, 12.5, 15, or 20 and/or up to 100, 75, 66.7, 60, 55, 50, 45, 40, 37.5, 35, 33.3, 32.5, 30, 27.5, 25, 22.5, 20, 15, or 10. Gypsum, i.e., CaSO₄·H₂O, may be present in a range of from 1 to 10 wt. %, e.g., at least 1, 2, 2.5, 3, 3.33, 3.67, 4, 4.25, 4.5, 4.75, or 5 wt. % and/or no more than 10, 9, 8.5, 8, 7.75, 7.5, 7.25, 7, 6.67, 6.5, 6.33, 6, 5.75, 5.67, 5.5, 5.33, 5.25, or 5 wt. %. The magnesium oxide content (MgO) may be no more than 5.0, 4.75, 4.5, 4.25, 4, 3.75, 3.5, 3.25, 3, 2.67, 2.75, 2.5, 2.33, 2.25, 2.1, 2, 1.9, 1.8, 1.75, 1.67, 1.5, 1.4, 1.33, 1.25, 1.2, 1.1, 1.05, 1 0.95, 0.9, 0.85, 0.8, 0.75, 0.7, 0.667, 0.65, 0.6, 0.55, 0.5, 0.45, 0.4, 0.35, 0.333, 0.3, 0.25, 0.2, 0.15, 0.125, 0.1, 0.05, 0.01, 0.001 wt. % or less. Typical Portland cements may contain calcium oxide, CaO (often designated C), in 60 to 70 wt. %; silicon dioxide, SiO₂ (often designated S), in 17.5 to 25 wt. %; aluminum oxide, Al₂O₃ (often designated A), in 17.5 to 25 wt. %; ferric oxide, Fe₂O₃ (often designated F), in 0 to 7.5 wt. %; and sulfur (VI) oxide, SO₃, in 1 to 5 wt. %.

For example, in the Portland cement, the CaO may make out at least 60, 61, 61.5, 62, 62.5, 63, 63.33, 63.5, 64, or 65 wt. % and/or up to 70, 69, 68.5, 68, 67.5, 67, 66.75, 66.67, 66.5, 66.25, 66, 65.75, 65.5, 65.25, or 65 wt. %. The SiO₂ may make out at least 17.5, 18, 18.5, 19, 19.25, 19.5, 19.75, 20, 20.33, 20.5, 20.67, 21, 21.33, 21.5, 21.67, 22, or 22.5 wt. % and/or up to 25, 24.75, 24.5, 24.25, 24, 23.75, 23.5, 23.25, 23, 22.67, 22.5, 22.33, 22, 21.75, 21.5, 21.25, or 21 wt. %, as may be the Al₂O₃, independently. The Fe₂O₃ may be absent or may make out a trace or at least 0.25, 0.5, 0.75, 1, 1.25, 1.5, 1.75, 2, 2.33, 2.5, 2.67, 3, 3.33, 3.5, 3.67, 4, or 5 wt. % and/or up to 7.5, 7. 6.75, 6.5, 6.25, 6, 5.75, 5.5, 5.25, 5, 4.67, 4.5, 4.33, 4, 3.75, 3.5, 3.25, 3, 2.75, 2.67, 2.5, 2.33, 2,25, 2, 1.75, 1.67, 1.5, 1.33, 1.25, 1.2, 1.1, 1, 0.9, 0.8, 0.75, 0.67, 0.6, 0.5, 0.45, 0.4, 0.33, 0.3, 0.25, 0.2, 0.15, 0.1, 0.05, 0.01 or 0.001 wt. %. The SO₃ may make out at least 1, 1.25, 1.5, 1.75, 2, 2.33, 2.5, 2.67, 3, 3.33, 3.5, 3.67, 4, 4.5, or 5 wt. % and/or up to 5, 4.75, 4.67, 4.5, 4.33, 4.25, 4, 3.75, 3.67, 3.5, 3.33, 3.25, 3, 2.75, 2.67, 2.5, 2.33, 2.25, 2.2, 2.1, 2, 1.9, 1.8, 1.75, 1.67, 1.6, 1.5, 1.45, 1.4, 1.33, 1.3, 1.25, 1.2, 1.15, 1.1, 1.05, 1 wt. %.

The aggregate may be slag, sand, carbonate rock, phosphate rock, igneous rock, sedimentary rock, and/or metamorphic rock, as well as combinations including these. For example the aggregates may include adakite, andesite, alkali feldspar granite, anorthosite, aplite, basalt, basaltic trachyandesite, mugearite, shoshonite, basanite, blairmorite, boninite, carbonatite, charnockite, enderbite, dacite, diabase (dolerite), diorite, napoleonite (corsite), dunite, essexite, foidolite, gabbro, granite, granodiorite, granophyres, harzburgite, homblendite, hyaloclastite, icelandite, ignimbrite, ijolite, kimberlite, komatiite, lamproite, lamprophyre, latite, lherzolite, monzogranite, monzonite, nepheline syenite, nephelinite, norite, obsidian, pegmatite, peridotite, phonolite, phonotephrite, picrite, porphyry, pumice, pyroxenite, quartz diorite, quartz monzonite, quartzolite, rhyodacite, rhyolite, comendite, pantellerite, scoria, shonkinite, sovite, syenite, tachylyte, tephriphonolite, tephrite, tonalite, trachyandesite, benmoreite, trachybasalt, hawaiite, trachyte, troctolite, trondhjemite, tuff, websterite, wehrlite, turbidite, argillite, arkose, breccia, calcarenite, chalk, chert, claystone, conglomerate, coquina, diamictite, diatomite, dolomite, evaporite, flint, geyserite, greywacke, gritstone, itacolumite, jaspillite, laterite, limestone, marl, mudstone, oolite, phosphorite, sandstone, shale, siltstone, sylvinite, tillite, travertine, tufa, turbidite, wackestone, phyllite, slate, amphibolites, blueschist, cataclasite, eclogite, gneiss, granulite, greenschist, hornfels, calcflinta, litchfieldite, marble, migmatite, mylonite, metapelite, metapsammite, pseudotachylite, quartzite, schist, serpentinite, skarn, suevite, talc carbonate, soapstone, tectonite, whiteschist, kyanite, adamellite, appinite, aphanite, borolanite, blue granite, epidosite, felsite, ganister, gossan, hyaloclastite, jadeitite, jasperoid, kenyte, lapis lazuli, larvikite, litchfieldite, llanite, luxullianite, mangerite, minette, novaculite, pietersite, pyrolite, rapakivi granite, rhomb porphyry, rodingite, shonkinite, taconite, tachylite, teschenite, theralite, unakite, variolite, vogesite, wad, or a mixture of these.

Inventive composition may include about 0.1% to about 5.0% by weight mercapto-alcohol and/or cysteine-based monomer derivative(s). For example, the composition may have at least 0.1, 0.125, 0.15, 0.175, 0.2, 0.25, 0.333, 0.4, 0.5, 0.667, 0.75, 1, 1.25, 1.5, 1.75, 2, 2.25, 2.5, 2.75, 3, 3.5, or 4 wt. % of the mercapto-alcohol and/or cysteine-based monomer derivative(s), and/or no more than 5, 4.9, 4.8, 4.75, 4.7, 4.667, 4.6, 4.5, 4.4, 4.333, 4.25, 4.2, 4.1, 4, 3.75, 3.667, 3.5, 3.33, 3.25, 3, 2.75, 2.5, 2.25, 2, 1.75, 1.5, 1.25, 1, 0.75, 0.667, 0.5, 0.4, 0.333, 0.25, 0.15, or 0.1 wt. % of one, two, or more of these, measured individually or together. Inventive compositions may comprise 1, 2, 3, 4, 5, or more of the mercapto-alcohol and/or cysteine-based monomer derivative(s).

The cysteine-based derivative(s) may have formula (I):

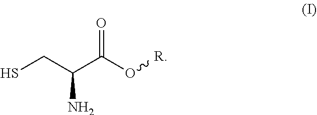

In formula (I), R may be independently H, a straight chain hydrocarbon, branched hydrocarbon, cyclic hydrocarbon, or aromatic hydrocarbons, which hydrocarbon may be substituted one or more alcohols, amines, amides, thiols, or carbonyl derivatives.

The mercapto-alcohol monomer derivatives may have general formula (II):

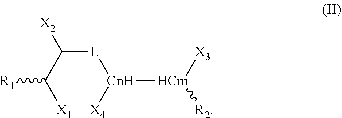

In formula (II), R₁ and R₂ may be independently H, a straight chain hydrocarbon, branched hydrocarbon, cyclic hydrocarbon, or aromatic hydrocarbons, which hydrocarbon may be substituted one or more alcohols, amines, amides, thiols, or carbonyl derivatives. The (divalent) aliphatic hydrocarbons useful may be C1, C2, C3, C4, C5, C6, C7, C8, C9, or C10 and/or up to C40, C36, C32, C28, C24, C22, C20, C18, C16, C14, C12, C10, C9, C8, C7, C6, C5, or C4, whereby the end-to-end chain between bonding points may be 1 to 30 carbons, 1 to 20 carbons, 1 to 10 carbons, 2 to 8 carbons, or 2 to 5 carbons, for example. Aromatic hydrocarbons may be at least C4, C5, C6, C8, C9, C10, C11, C12, C13, C14 and/or up to C40, C36, C32, C28, C24, C20, C16, C12, C10, C9, or C8 or C6, including having 1, 2, 3, 4 or more of N, O, S, Se, and/or P. The same may be true for R in formula (I), independently of the structure of formula (II).

In formula (II), X₁, X₂, X₃, and X₄ may independently be OH or SH, but at least one of X₁, X₂, X₃, and X₄ should be SH. For example, 1, 2, or 3 OH may be present with 3, 2, or 1 SH.

In formula (II), n and m may independently be 0 or 1.

In formula (II), L. may be independently H, a straight chain hydrocarbon, branched hydrocarbon, cyclic hydrocarbon, or aromatic hydrocarbons, which hydrocarbon may be substituted one or more alcohols, amines, amides, thiols, or carbonyl derivatives.

Relevant hydrocarbons of R, R₁, R₂, and L in formulas (I) and (II) may be, for example, methyl, ethyl, C3s or 3-carbon alkyl groups, such as propyl, isopropyl, cyclopropyl; C4s or 4-carbon alkyl groups, such as n-butyl, s-butyl, isobutyl, tert-butyl, cyclobutyl, etc.; C5s or 5-carbon alkyl groups, such as n-pentyl, s-pentyl, isopentyl, neopentyl, cyclopentyl, etc.; C6s or 6-carbon alkyl groups, such as n-hexyl, s-hexyl, isohexyl, 2,3-dimethylbutyl, 2-ethylbutyl, 3-methylpentyl, 4-methylpentyl, cyclohexyl, methylcyclopentyl, etc.; C7s or 7-carbon alkyl groups; C8s or 8-carbon alkyl groups; C9s or 9-carbon alkyl groups; C10s or 10-carbon alkyl groups, etc., which may include bicyclics, spiro compounds, and the like. Relevant aromatic (including heteroaromatic) hydrocarbons of R, R₁, or R₂ in formulas (I) and (II) may be, for example, benzene, pyrrole, furan, thiophene, imidazole, 1,2,4-triazole, oxazole, thiazole, isothiazole, pyridine, pyrimidine, indene, 3H-indole, 2H-indole, 1H-indole, indolizine, benzimidazole, purine, benzofuran, isobenzofuran, benzo[c]thiophene, benzo[b]thiophene, benzo[d]isoxazole, benzo[c]isoxazole, benzo[d]isothiazole, benzo[c]isothiazole, benzo[d]oxazole, benzo[d]thiazole, benzo[e]thiadiazole, azulene, naphthalene, quinoline, isoquinoline, anthracene, phenanthrene, fluorene, carbazole, dibenzofuran, acridine, phenazine, phenoxazine, phenothiazine, phenoxathiine, phenalene, tetracene, chrysene, pyrene, or triphenylene substituents, for example. Alkylaromatics, such as benzyl (methylphenyl), ethylphenyl, o-, m-, or p-xylyl, mesityl, duryl, biphenyland combinations of the moieties mentioned for “hydrocarbons” and “aromatic hydrocarbons” are also included in the aromatic hydrocarbon rubric.

L in formula (II) may be an optionally substituted methylene, ethylene, propylene, butylene, etc., which may be interrupted by one, two, or three —O—, —S—, —N(R^{a})—, —P(R^{a})—, carbonyl, sulfonyl, sulfinyl, or the like (also as combinations, such as ether-sulfide, etc.), such as CH₂OCH₂, CH₂SCH₂, CH₂N(R^{a})CH₂, CH₂P(R^{a})CH₂, CH₂OCH₂CH₂, CH₂SCH₂CH₂, CH₂N(R^{a})CH₂CH₂, CH₂P(R^{a})CH₂CH₂, CH₂CH₂OCH₂CH₂, CH₂CH₂SCH₂CH₂, CH₂CH₂N(R^{a})CH₂CH₂, CH₂CH₂P(R^{a})CH₂CH₂, CH₂OCH₂CH₂CH₂, CH₂SCH₂CH₂CH₂, CH₂N(R^{a})CH₂CH₂CH₂, CH₂P(R^{a})CH₂CH₂CH₂, CH₂CH₂OCH₂CH₂CH₂, CH₂CH₂SCH₂CH₂CH₂, CH₂CH₂N(R^{a})CH₂CH₂CH₂, CH₂CH₂P(R^{a})CH₂CH₂CH₂, wherein 1, 2, 3, 4, or 5 protons of any of the foregoing may be replaced by a substituent, which are the same as R^{a}. R^{a} may independently be, hydrogen, alkyl, azide, amine, nitrile, isonitrile, cyanate, isocyanate, thiocyanate, isothiocyanate, nitro, nitroso, thiol, thioether, fluoride, chloride, bromide, iodide, methyl, ethyl, n-propyl, isopropyl, n-butyl, isobutyl, sec-butyl, methoxy (OCH₃), ethoxy (OCH₂CH₃), propoxy (OCH₂CH₂CH₃), isopropoxy (OCH(CH₃)₂), butoxy (OCH₂CH₂CH₂CH₃), isobutoxy, sec-butoxy, cyano, methoxymethyl, methoxyethyl, ethoxymethyl, hydroxy, C₁-C₄ carboxylate (reverse), C₀-C₄ sulfonate, C₁-C₄ (reverse) amide, C₁-C₄ (reverse) ester, C₁-C₄ (reverse) carbamate, C₁-C₄ (reverse) sulfonamide, C₁-C₄ ketone, or C₁-C₄ aldehyde. The term “reverse” in the preceding meaning, for example, that L could be an ester in a direction —C(O)O— or in a “reverse” direction a follows —OC(O)—, which may also apply mutatis mutandis to amides, sulfonamides, carbamates, sulfonates, sulfoxides, etc.

The mercapto-alcohol may also have a structure (HS)ₙ—R—(OH)ₘ, wherein R is a straight, branched, cyclic, or heterocyclic alkylene, hydrocarbon moiety having from 1 to 30 carbon atoms; n and me are independently 1, 2, 3, 4, or 5. The hydrocarbon may have, for example, at least 1, 2, 3, 4, 5, 6, 7, or 8 carbon atoms, and/or no more than 30, 28, 26, 24, 22, 20, 18, 17, 16, 15, 14, 13, 12, 11, 10, 9, 8, 7, 6, 5, 4, 3, or 2 carbon atoms. In any of the above formulas, a ratio of branch-carbons to total carbons branched hydrocarbons may be, for example, at least 1:30, 1:15, 1:10, 2:15, 1:6, 1:5, 7:30, 4:15, 3:10, 1:3, 11:30, 2:5, 13:30, 7:15, 1:2, 8:15, 17:30, 3:5, 19:30, 2:3, 7:10, 11:15, 23:30, 4:5, 5:6, 13:15, 9:10, 14:15, or 29:30 and/or no more than 29:30, 14:15, 9:10, 13:15, 5:6, 4:5, 23:30, 11:15, 7:10, 2:3, 19:30, 3:5, 17:30, 8:15, 1:2, 7:15, 13:30, 2:5, 11:30, 1:3, 3:10, 4:15, 7:30, 1:5, 1:6, 2:15, 1:10, 1:15, or 1:30. The heteroatom in the heterocyclic form may be N, O, S, or P.

The mercapto-alcohol may be 2-mercaptoethanol, 2-mercaptopropanol, 1-mercapto-2-propanol, 2-mercaptobutanol, 3-mercaptobutanol, 2-mercaptopentanol, 3-mercaptopentanol, 4-mercaptopentanol, 5-mercaptopentanol, etc. The mercapto-alcohol may be a C2, C3, C4, C5, C6, C7, C8, C9, or C10 hydrocarbon, for example, with 1, 2, 3, or 4 alcohols. The mercapto-alcohol may have 1, 2, 3, or 4 excess thiol, relative to the alcohol(s), but it may alternatively have 1, 2, 3, or 4 excess alcohol, relative to the thiol(s). Combinations of mercapto-alcohol may be used in which 1, 2, or 3 species are present with excess thiol (per molecule on a substituent basis), and 1, 2, or 3 species are present with excess alcohol. The mercapto-alcohol may be a sugar in which 1, 2, 3, or 4, OH are replaced by SH, e.g., a triose (3), tetrose (4), pentose (5), hexose (6), heptose (7), etc., such as erithrose, threose, ribose, arabinose, xylose, lyxose, allose, altrose, glucose, manose, gulose, iodose, galactose, talose, lactose, fructose, maltose, or a sugar alcohol, such as glycerol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, etc.

The addition of one or more mercapto-alcohol monomer derivatives and/or cysteine-based monomer derivatives may increase the compressive strength of the resulting concrete by about 25% compared to conventional concrete. For example the compressive strength increase may be at least at least 2.5, 5, 7.5, 10, 12.5, 15, 17.5, 20, 25, 33%, and/or up to 75, 67, 60, 50, 40, 37.5, 33, 30, 27.5, 25, 22.5, 20, 15, 10, or 5%.

The addition of mercapto-alcohol monomer derivatives and/or cysteine-based monomer derivatives may reduce the required water content in the concrete composition of the present disclosure by about 25% compared to conventional concrete compositions. For example the water reduction may be at least at least 2.5, 5, 7.5, 10, 12.5, 15, 17.5, 20, 25, 33%, and/or up to 75, 67, 60, 50, 40, 37.5, 33, 30, 27.5, 25, 22.5, 20, 15, 10, or 5%.

The addition of mercapto-alcohol monomer derivatives and/or cysteine-based monomer derivatives may enhance the durability characteristics of the resulting concrete compared to conventional concrete. The durability characteristics may be, for example, 5, 10, 15, 20, 25, 33, 50, 75, 100, or 200% improved over otherwise identical formulations lacking the mercapto-alcohol and/or cysteine-based monomer derivative(s). This may be, e.g., a 1.1-fold, 1.15-fold, 1.2-fold, 1.25-fold, 1.33-fold, 1.45-fold, 1.5-fold, 1.75-fold, 2-fold, 2.5-fold, 3-fold, 5-fold, 10-fold, or even 20-fold improved.

The addition of mercapto-alcohol monomer derivatives and/or cysteine-based monomer derivatives may promote and accelerates the hydration of cement under room temperature curing conditions. For example, the hydration time may be at least at least 2.5, 5, 7.5, 10, 12.5, 15, 17.5, 20, 25, 33, 50, 75, 100, 150, 200, 250, 500, 750, 1,000, 10,000%, and/or up to 100,000, 10,000, 1,000, 750, 500, 250, 150, 100, 75, 67, 60, 50, 40, 37.5, 33, 30, 27.5, 25, 22.5, 20, 15, 10, or 5% reduced.

The addition of mercapto-alcohol monomer derivatives and/or cysteine-based monomer derivatives may facilitate the hydration reactions of cement at early stages without negatively impacting the long-term strength of the concrete.

The addition of mercapto-alcohol monomer derivatives and/or cysteine-based monomer derivatives may reduce in cement content in concrete mixtures without compromising the compressive strength of the hardened concrete.

The mercapto-alcohol monomer derivatives and/or cysteine-based monomer derivatives described herein possess to function as reducing and chelating agents via SH group with multiple chelating sites within the monomer. However, the reducing activities may be eliminated due to the pH value of the cement mixture. Consequently, the monomers may act as chelating agents within the cement mixture.

The disclosure is now further illustrated on the basis of examples and a detailed description from which further features and advantages may be taken. It is to be noted that the following explanations are presented for the purpose of illustration and description only; they are not intended to be exhaustive or to limit the disclosure to the precise form disclosed.

### Example 1

### Evaluate the Role of Thiol Groups in the Cement Mixture

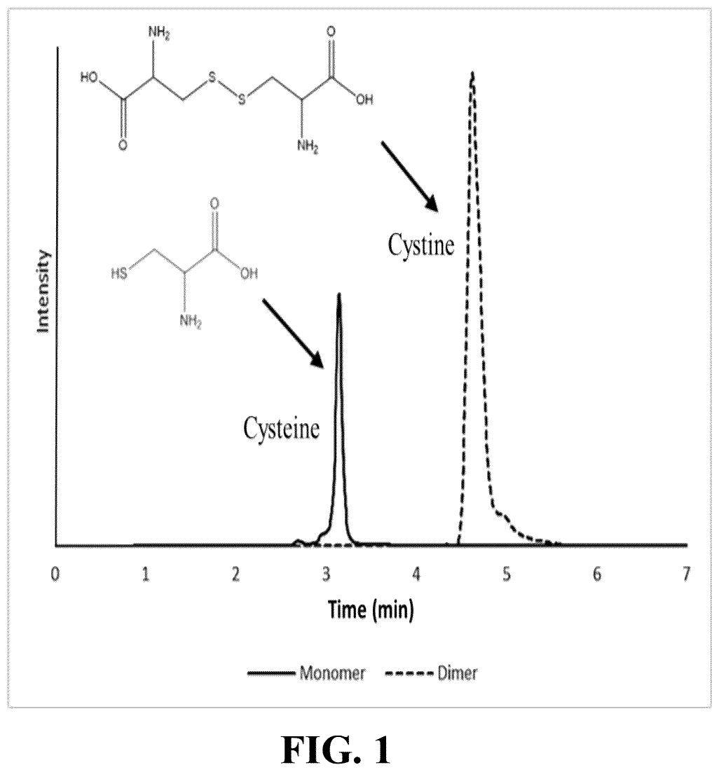

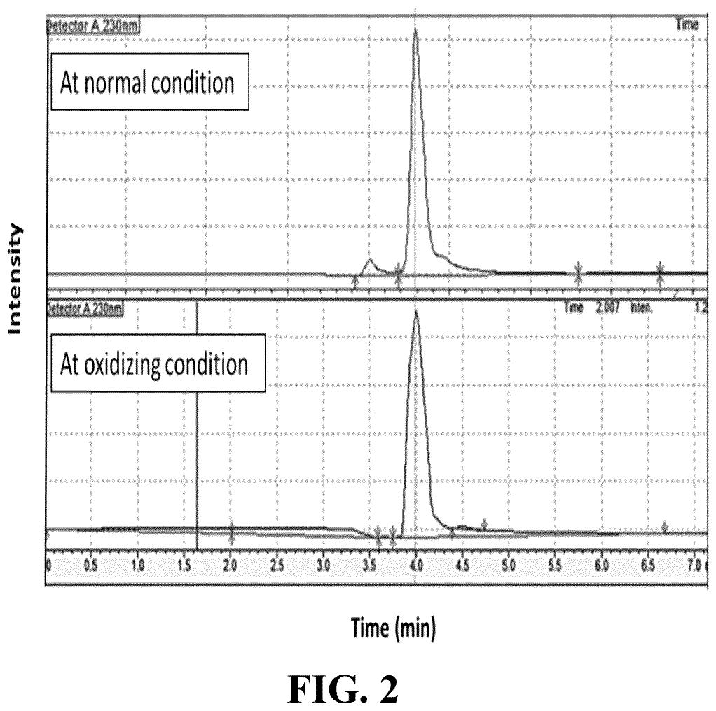

In this example, reference will be made to FIGS. 1 and 2. In this example, the role of thiol group was evaluated by oxidizing the monomers generating a dimer. About 10% by volume aqueous NaOH solution was added to about 0.56 M of mercapto (thiol) series (cysteine, cysteine methyl ester, beta-mercaptoethanol, and dithiothreitol), then a neutralization step was performed using about 3.0% by volume aqueous solution of hydrogen peroxide. Subsequently, centrifugation was performed at about 3000 rpm for about 5 minutes, then the supernatant was discarded and the pellets were recrystallized followed by rinsing with a few drops of cold water.

The dimerization process was evaluated using reverse-phase HPLC. For the analysis, about 5 μL injection volume was used. The mobile phase consisted of a mixture of acetonitrile and water in a ratio of about 65:35. The results obtained from the analysis revealed successful formation of cysteine dimer (cystine) (FIG. 1). Two distinct peaks were identified at distinct retention times. Similar findings were noted for all other derivatives of mercapto-alcohol, including beta-mercaptoethanol and dithiothreitol.

In the case of cysteine methyl ester, a solitary peak was seen regardless of the oxidation environment, consistently appearing at a retention time of 4 minutes (FIG. 2). therefore, cysteine methyl ester was unable to form a dimer. The modification of the carboxylic group to a methyl ester increased the acidity of the ammonium protons relative to the thiol protons. This alteration significantly hindered the formation of disulfide bonds. Therefore, cysteine methyl ester exhibited lower reactivity compared to cysteine. The inhibitory effect of the ester group on disulfide bond formation was attributed to the presence of the methyl ester group in cysteine methyl ester.

### Example 2

### Chelating and Reducing Properties

Mercapto alcohol and cysteine ionized when introduced into the cement mixture due to its pH value. This reaction highlights their distinct attributes, as all proposed mercapto alcohol and cysteine derivatives exhibit a dual nature, possessing both chelating and reducing properties as illustrated in Table 1. The reduction attributes of these compounds are subject to pH conditions, specifically, in the alkaline media of the cement mixture where the pH is around 12. In this context, a proton loss occurs, leading to a reduction in the reducing activity within the cement matrix. Simultaneously, the chelating properties are enhanced, contributing to their overall efficacy within the cement mixture.

TABLE 1

| | # of | | | Chelated | Pka values & |
|---|---|---|---|---|---|
| Name | Carbons | Structure | Reduced Form | Form | charge at pH 12 |
| β-mercapto ethanol | 2 | 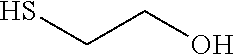 | 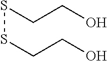 | 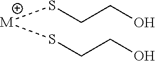 | 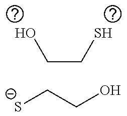 |
| cysteine | 3 | 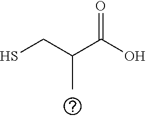 | 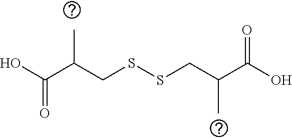 | 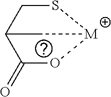 | 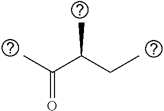 |
| | | | | | 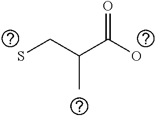 |
| 2,3-disulfanylpropan-1-ol | 3 | 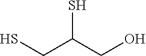 | 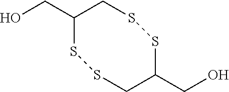 | 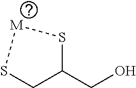 | 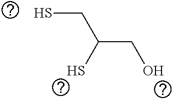 |
| | | | | | 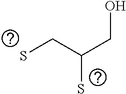 |
| dithiothreitol | 4 | 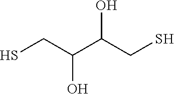 | 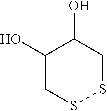 | 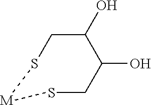 | 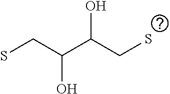 |
| | | | 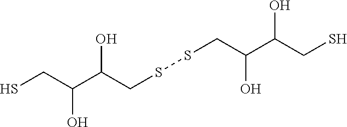 | | 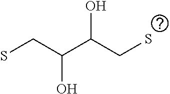 |
| cysteine methyl ester | 4 | 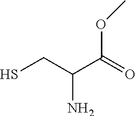 | 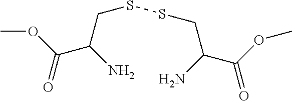 | 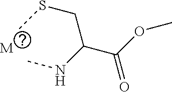 | 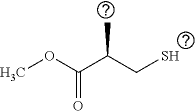 |
| | | | | | 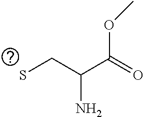 |
| 3,4-disulfanyl-butane-1,2-diol | 4 | 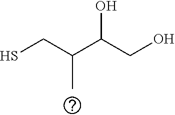 | 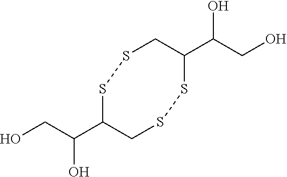 | 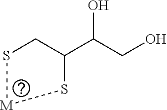 | 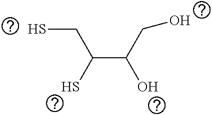 |
| | | | | | 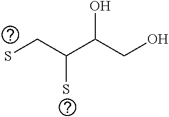 |

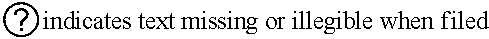

In Table 1 above, the pKa of the SH is 8.51 and the pKa of the OH is 16.25 in β-mercaptoethanol, the pKa of the SH is 6.61, the pKa of the COOH is 2.35, and the pKa of the NH₂ is 9.54, in the cysteine; the pKa of the secondary SH is 8.05, the pKa of the primary SH is 8.95, and the pKa of the OH is 15.79, in the 2,3-disulfanylpropan-1-ol; the pKa of the first SH is 8.12 and the pKa of the second SH is 8.72 in the dithiothreitol; the pKa of the SH is 6.86 and the pKa of the NH₂ is 7.93 in the cysteine methyl ester; the pKa of the secondary SH is 7.98, the pKa of the primary SH is 8.93, the pKa of the secondary OH is 14.29, and the pKa of the primary OH is 15.82, in the 3,4-disulfanylbutane-1,2-diol.

### Example 3

### Compressive Strength

In this example, the compressive strength was studied for mortar and concrete specimens after adding cysteine-based monomer derivatives. By referring to Table 2, the mortar mixtures were prepared by incorporating silica sand at a weight ratio of about 2.75 to cement, with constant water-to-cement ratio of about 0.5 and amino acids at a concentration of about 1.0% by weight of cement. Six specimens in the form of about 50-mm cubic units of mortar were prepared for each mixture, and three specimens were subjected to compression testing at each age.

The compressive strength were studied for cubic specimens with dimensions of about 100 mm of concrete specimens after adding both oxidizing states of mercapto-alcohol monomer derivatives (monomers and dimers),. By referring to Table 3, compression tests were carried out at the age of 7 and 28 days after moist curing at room temperature. Coarse aggregates of about 9.5 mm limestone were added to the concrete mixture, with a constant water-to-cement ratio of about 0.6. The amino acid was added at a concentration of about 1 M. Similarly, six specimens were prepared for each mixture, and three specimens were subjected to compression testing at each age.

TABLE 2

| | | | | | Strength | Strength |
|---|---|---|---|---|---|---|
| | Cement | Sand | Water | Amino | (MPa) | (MPa) |
| Specimen | (g) | (g) | (g) | Acid (g) | 7 days | 28 days |
| 100% OPC* | 480 | 1320 | 240 | — | 36.8 | 46.6 |
| 100% OPC with | 480 | 1320 | 240 | 4.8 | 46.0 | 58.7 |
| Cysteine | | | | | | |
| 100% OPC with | 480 | 1320 | 240 | 4.8 | 51.8 | 61.9 |
| Cysteine Methyl | | | | | | |
| Ester | | | | | | |
| 100% OPC with | 480 | 1320 | 240 | 4.8 | 37.7 | 47.2 |
| Phenylalanine | | | | | | |
| 100% OPC with | 480 | 1320 | 240 | 4.8 | 37.7 | 46.0 |
| Proline | | | | | | |
| 100% OPC with | 480 | 1320 | 240 | 4.8 | 41.1 | 52.8 |
| Tyrosine | | | | | | |
| 100% OPC with | 480 | 1320 | 240 | 4.8 | 39.8 | 50.5 |
| Tryptophan | | | | | | |

TABLE 3

| | | | | | | Strength | Strength |
|---|---|---|---|---|---|---|---|
| | Cement | Water | Sand | Aggregate | Monomer | (MPa) | (MPa) |
| Specimen | (g) | (g) | (g) | (g) | (g) | 7 days | 28 days |
| 100% OPC | 360 | 216 | 540 | 900 | — | 44,23 | 54.10 |
| 75% OPC | 270 | 162 | 540 | 900 | — | 38.57 | 47.90 |
| 75% OPC with | 270 | 162 | 540 | 900 | 2.55 | 51.40 | 67.20 |
| dithiothreitol | | | | | | | |
| monomer | | | | | | | |
| 75% OPC with | 270 | 162 | 540 | 900 | 5.06 | 46.53 | 56.27 |
| dithiothreitol | | | | | | | |
| dimer | | | | | | | |
| 75% OPC with | 270 | 162 | 540 | 900 | 2.00 | 51.63 | 60.97 |
| cysteine | | | | | | | |
| 75% OPC with | 270 | 162 | 540 | 900 | 3.97 | 46.23 | 57.47 |
| Cysteine dimer | | | | | | | |
| 75% OPC with | 270 | 162 | 540 | 900 | 2.83 | 51.83 | 63.03 |
| cysteine methyl | | | | | | | |
| ester | | | | | | | |
| 75% OPC with | 270 | 162 | 540 | 900 | 5.63 | 50.60 | 62.40 |
| cysteine methyl | | | | | | | |
| ester oxide | | | | | | | |
| 75% OPC with β- | 270 | 162 | 540 | 900 | 1.29 | 42.47 | 58.53 |
| mercaptoethanol | | | | | | | |
| 75% OPC with β- | 270 | 162 | 540 | 900 | 2.55 | 42.93 | 48.37 |
| mercaptoethanol | | | | | | | |
| dimer | | | | | | | |
| 75% OPC with | 270 | 162 | 540 | 900 | 4.82 | 40.27 | 53.03 |
| EDTA | | | | | | | |

While embodiments of the present disclosure have been described in detail and with reference to specific embodiments thereof, it will be apparent to one skilled in the art that various additions, omissions, and modifications can be made without departing from the spirit and scope thereof.

In describing and claiming the present invention, the following terminology was used.

The singular forms “a,” “an,” and “the” include plural referents unless the context clearly dictates otherwise.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

As used herein, the term “about”, when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

What is claimed is:

1. A concrete composition, comprising:
Portland cement;
aggregates; and
a mercapto-alcohol and/or cysteine-based monomer derivative.

2. The composition of claim 1, comprising the mercapto-alcohol and/or cysteine-based monomer derivative in a range of from 0.1 to 5.0 wt. %, based on total dry concrete composition weight.

3. The composition of claim 1, wherein the cysteine-based derivative is present has formula (I): 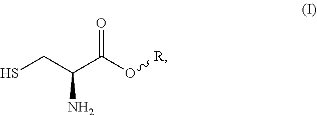
wherein R is H, a straight chain hydrocarbon, branched hydrocarbon, cyclic hydrocarbon, or aromatic hydrocarbon, the hydrocarbon optionally comprising an alcohol, amine, amide, thiol, and/or carbonyl derivative, as a substituent.

4. The composition of claim 1, wherein the mercapto-alcohol monomer derivative is present and has formula (II): 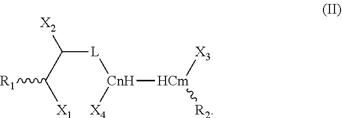
wherein
R₁ and R₂ are independently H, a straight chain hydrocarbon, branched hydrocarbon, cyclic hydrocarbon, or aromatic hydrocarbon, the hydrocarbon optionally comprising an alcohol, amine, amide, thiol, and/or carbonyl derivative, as a substituent,
L is a straight chain hydrocarbon, branched hydrocarbon, cyclic hydrocarbon, or aromatic hydrocarbons, the hydrocarbon optionally comprising an alcohol, amine, amide, thiol, and/or carbonyl derivative, as a substituent,
X₁, X₂, X₃, and X₄ are independently OH or SH, with at least one of X₁, X₂, X₃, and X₄ being SH, and
n and m are independently 0 or 1.

5. The composition of claim 3, wherein R in the cysteine-based derivative of formula (I) is a straight chain hydrocarbon.

6. The composition of claim 3, wherein R in the cysteine-based derivative of formula (I) is a branched hydrocarbon.

7. The composition of claim 3, wherein R in the cysteine-based derivative of formula (I) is an aromatic hydrocarbon.

8. The composition of claim 4, wherein at least one of R₁, R₂, and L in the mercapto-alcohol monomer derivative of formula (II) is a straight chain hydrocarbon.

9. The composition of claim 4, wherein R₁, R₂, and L in the mercapto-alcohol monomer derivative of formula (II) are each independently a straight chain hydrocarbon.

10. The composition of claim 1, wherein the mercapto-alcohol and/or cysteine-based monomer derivative comprises β-mercapto ethanol, cysteine, 2,3-disulfanylpropan-1-ol, dithiothreitol, cysteine methyl ester, and/or 3,4-disulfanyl-butane-1,2-diol.

11. The composition of claim 1, wherein the mercapto-alcohol and/or cysteine-based monomer derivative comprises cysteine.

12. The composition of claim 1, wherein the mercapto-alcohol and/or cysteine-based monomer derivative comprises an ester of cysteine.

13. The composition of claim 1, wherein the mercapto-alcohol and/or cysteine-based monomer derivative comprises β-mercapto ethanol, 2,3-disulfanylpropan-1-ol, dithiothreitol, and/or 3,4-disulfanyl-butane-1,2-diol.

14. A method of increasing compression strength in a set concrete, the method comprising:
pouring a hydrated form of the composition of claim 1; and
allowing the hydrated form of the concrete composition to for a set concrete,
wherein the set concrete has a higher compression strength than that from an otherwise identical composition lacking the mercapto-alcohol and/or cysteine-based monomer derivative.

15. The method of claim 14, wherein the compression strength is increased in the set concrete by up to 50%, relative to that of the otherwise identical composition.

16. A method of reducing water requirements of a concrete mixture, the method comprising:
combining water and a mercapto-alcohol and/or cysteine-based monomer derivative with a Portland cement and aggregate to obtain the concrete composition of claim 1,
wherein the composition requires less of the water to reach the same flow viscosity than an otherwise identical composition lacking the mercapto-alcohol and/or cysteine-based monomer derivative.

17. A method of increasing durability of set concrete, the method comprising:
pouring a hydrated form of the composition of claim 1; and
allowing the concrete composition to set to form a set concrete,
wherein the set concrete has a higher durability than an otherwise identical composition lacking the mercapto-alcohol and/or cysteine-based monomer derivative.

18. A method of accelerating hydration of concrete mixture, the method comprising:
combining components of the composition of claim 1 with water, to obtain a concrete mixture; and
allowing the concrete mixture to hydrate and optionally set,
wherein the concrete composition hydrates faster than an otherwise identical composition lacking the mercapto-alcohol and/or cysteine-based monomer derivative.
